(19) United States
(12) Patent Application Publication
(10) Pub. No.: US 2017/0148115 A1
(43) Pub. Date: May 25, 2017

(54) SYSTEM AND METHOD FOR PROVIDING A SMART FUEL GAUGE AND RELATED SMART FUEL GAUGE APPARATUS

(71) Applicant: Nikolaos Spanos, New York, NY (US)

(72) Inventor: Nikolaos Spanos, New York, NY (US)

(21) Appl. No.: 15/275,393

(22) Filed: Sep. 24, 2016

Related U.S. Application Data
(60) Provisional application No. 62/257,473, filed on Nov. 19, 2015.

(51) Int. Cl. G06Q 50/06; B60K 35/00; B60K 15/03; G06Q 40/04; G06Q 20/10

(52) U.S. Cl. CPC G06Q 50/06; G06Q 40/04; G06Q 20/10; B60K 15/03; B60K 35/00; B60K 2015/03217; B60K 2015/03197

(57) ABSTRACT

The present invention generally relates to a system for creating a consumer market for gasoline enabled by a computerized (“smart”) fuel gauge that will communicate via an Internet connection with participating near-by gasoline stations to purchase specific amounts of gasoline using pre-loaded funds. Gasoline stations can broadcast their rate (price) for gasoline and/or provide individual vehicles with a custom rate depending on the amount and quality of gasoline requested. Vehicles will also be able to request a custom rate and the gasoline station has the option to accept it. Vehicles can set their interest in accepting offers based on the level of their current gasoline supply.

### CROSS-REFERENCE TO RELATED APPLICATIONS

The present application claims priority from provisional application No. 62/257,473, the contents of which are incorporated by reference herein in its entirety.

### FIELD OF THE INVENTION

The present invention generally relates to a system for creating a consumer market for gasoline enabled by a computerized (“smart”) fuel gauge that will communicate via an Internet connection with participating near-by gasoline stations to purchase specific amounts of gasoline using pre-loaded funds. Gasoline stations can broadcast their rate (price) for gasoline and/or provide individual vehicles with a custom rate depending on the amount and quality of gasoline requested. Vehicles will also be able to request a custom rate and the gasoline station has the option to accept it. Vehicles can set their interest in accepting offers based on the level of their current gasoline supply.

### BACKGROUND OF THE INVENTION

There is a need in the art for a system and method for providing a smart fuel gauge and related smart fuel gauge apparatus. These and other features and advantages of the present invention will be explained and will become obvious to one skilled in the art through the summary of the invention that follows.

### SUMMARY OF THE INVENTION

Accordingly, it is an object of the present invention to provide a system and method for providing a smart fuel gauge and related smart fuel gauge apparatus.

According to an embodiment of the present invention, a system for providing a smart fuel gauge and related smart fuel gauge apparatus comprises: a smart fuel gauge apparatus comprising a first processor, a first non-volatile computer readable memory and a first data communications means; wherein said first processor is communicatively connected to said communications means, and wherein said first non-volatile computer-readable memory is configured with computer instructions configured to instruct said first processor to: receive a fuel level reading; calculate a fill amount, said fill amount being the delta between said fuel level reading and a set capacity amount; and transmit said fill amount, via said communications means, to one or more fuel station computing devices; said fuel station computing device comprising a second processor, a second non-volatile computer readable memory and a second data communications means, wherein said second non-volatile computer-readable memory is configured with computer instructions configured to instruct said second processor to: receive said fill amount; generate an offer to provide fuel in the amount of said fill amount, wherein said offer is based at least in part on said fill amount; and transmit said offer to said smart fuel gauge apparatus.

According to an embodiment of the present invention, the first processor is communicatively connected to said communications means, and wherein said first non-volatile computer-readable memory is configured with computer instructions configured to instruct said first processor to: receive said offer from said fuel station computing device; and transmit to said fuel station computing device an acceptance of said offer.

According to an embodiment of the present invention, the second data communications means, wherein said second non-volatile computer-readable memory is configured with computer instructions configured to instruct said second processor to: receive said acceptance of said offer from said smart fuel gauge apparatus; receive payment processing information; and transmit, upon completion of fulfilling provision of fuel, a completion confirmation to said smart fuel gauge apparatus.

According to an embodiment of the present invention, the first processor is communicatively connected to said communications means, and wherein said first non-volatile computer-readable memory is configured with computer instructions configured to instruct said first processor to: receive said completion confirmation from said fuel station computing device; and finalize payment on said offer.

According to an embodiment of the present invention, the second data communications means, wherein said second non-volatile computer-readable memory is configured with computer instructions configured to instruct said second processor to: receive confirmation of said payment on said offer; and transmit a receipt for said payment to said smart fuel gauge apparatus.

According to an embodiment of the present invention, a method for providing a smart fuel gauge and related smart fuel gauge apparatus comprises the steps of: receiving a fuel level reading; calculating a fill amount, said fill amount being the delta between said fuel level reading and a set capacity amount; and transmitting said fill amount, via said communications means, to one or more fuel station computing devices; receiving said fill amount at a first fuel station computing device of said one or more fuel station computing devices; generating an offer to provide fuel in the amount of said fill amount, wherein said offer is based at least in part on said fill amount; and transmitting said offer to said smart fuel gauge apparatus.

According to an embodiment of the present invention, the method further comprises the steps of: receiving said offer from said fuel station computing device; and transmitting to said fuel station computing device an acceptance of said offer.

According to an embodiment of the present invention, the method further comprises the steps of: receiving said acceptance of said offer from said smart fuel gauge apparatus; receiving payment processing information; and transmitting, upon completion of fulfilling provision of fuel, a completion confirmation to said smart fuel gauge apparatus.

According to an embodiment of the present invention, the method further comprises the steps of: receiving said completion confirmation from said fuel station computing device; and finalizing payment on said offer.

According to an embodiment of the present invention, the method further comprises the steps of: receiving confirmation of said payment on said offer; and transmitting a receipt for said payment to said smart fuel gauge apparatus.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a diagram of a system for providing a smart fuel gauge and related smart fuel gauge apparatus, in accordance with an embodiment of the present invention.

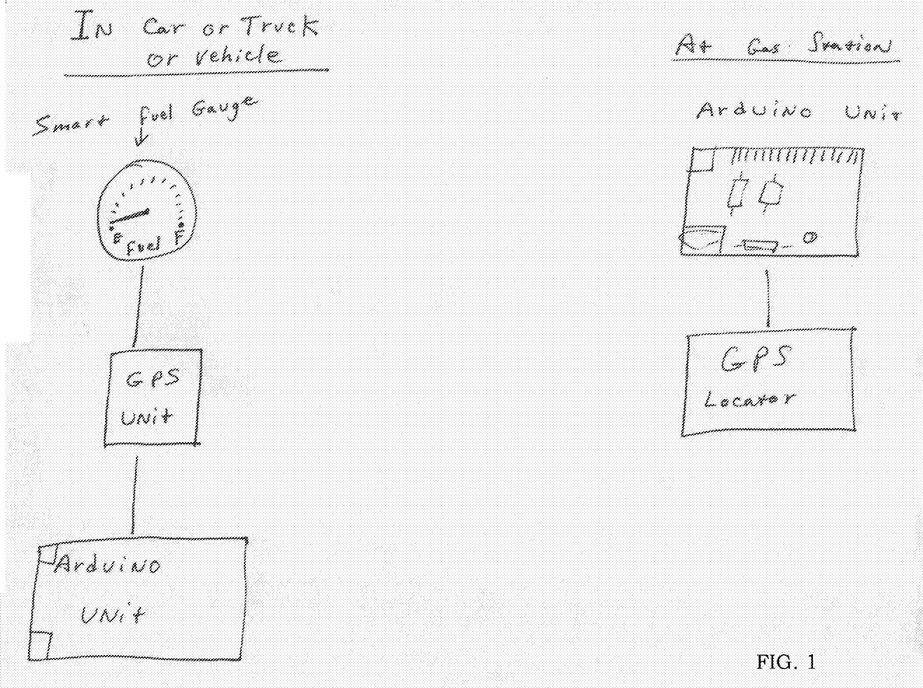

FIG. 2 is a flowchart showing a process for providing a smart fuel gauge and related smart fuel gauge apparatus, in accordance with an embodiment of the present invention.

### DETAILED SPECIFICATION

The present invention generally relates to a system for creating a consumer market for gasoline enabled by a computerized (“smart”) fuel gauge that will communicate via an Internet connection with participating near-by gasoline stations to purchase specific amounts of gasoline using pre-loaded funds. Gasoline stations can broadcast their rate (price) for gasoline and/or provide individual vehicles with a custom rate depending on the amount and quality of gasoline requested. Vehicles will also be able to request a custom rate and the gasoline station has the option to accept it. Vehicles can set their interest in accepting offers based on the level of their current gasoline supply. For example, in order to increase traffic a gasoline station may send out a customized offer that is lower than the advertised rate for gasoline to a vehicle that has more than a half full tank of gasoline in order to incentivize them to purchase gasoline as they pass the station. Once an offer has been accepted by both parties, the full amount for the gasoline at the agreed upon rate is automatically transferred to the gasoline station from the vehicle's pre-loaded funds. The vehicle is given a digital receipt that can be re-sold on a secondary market if the gasoline is not received at the time of payment.

Once an offer has been accepted by both parties, an X % deposit on the gasoline at the agreed upon rate is automatically transferred to the gasoline station from the vehicle's pre-loaded funds. The vehicle is given a digital receipt that gives them the option of purchasing the agreed amount at the agreed rate for X days in the future.

According to an embodiment of the present invention, a smart fuel gauge in is intended to be incorporated into a vehicle and is configured to sense fuel level of the vehicle while also providing a means for transmitting and receiving requests for provision of fuel, generally in the amount required to fill a fuel tank of the vehicle. However, in alternative embodiments, a user selected or otherwise selected amount of fuel may be requested (e.g., an amount less than a full tank, an amount based on an exact amount of currency to be exchanged for the transaction).

According to an embodiment of the present invention, the smart fuel gauge may further comprise one or more of a display element, a power source and a processing unit (i.e., computing means). The display element may be configured to display information associated with the smart fuel gauge, such as average fuel cost in the area, number of fuel stations in the area, number of fuel stations in range of the vehicle's expected max range, total fuel required, operating time, or any combination thereof. In certain embodiments, the display element may be part of the processing unit and in other embodiments, the display element may be separate and distinct from the processing unit. In still further embodiments, more than one display element may be used, such as one display element specifically for displaying current fuel levels, and a second display element present associated with the processing unit. In certain embodiments, the display element may also work as a human interface device (HID) and accept commands or other input from a user. For instance, the display element could be a capacitive touch screen or other interactive display.

According to an embodiment of the present invention, the processing unit comprises a processor, a memory, a communications means (such as circuitry for transmitting and receiving data via a communications protocol, such as BLUETOOTH or WIFI) and a location identification means (e.g., global positioning systems and circuitry therefore). In a preferred embodiment, the processing unit is configured to calculate a fill amount (e.g, an amount required to fill a fuel tank of the vehicle) and transmit that fill amount to a remote computing device of one or more fuel stations via the communications means. The communications means of both the remote computing devices and the smart fuel gauge will communicate with one another to effect the methods described herein.

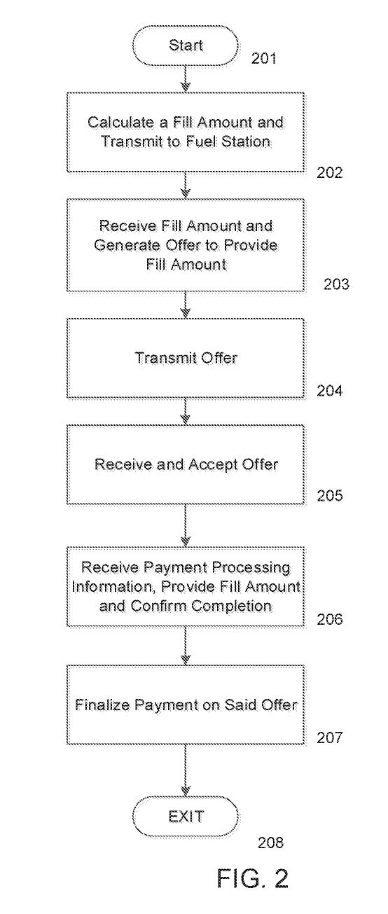

Turning now to FIG. 2, an exemplary method in accordance with an embodiment of the present invention is shown. In this method, the process starts at step 201 with a smart fuel gauge processing fill amounts during a trip of a vehicle. At step 202, the smart fuel gauge calculates a fill amount and transmits the fill amount to a fuel station.

At step 203, the fuel station receives the fill amount and generates an offer to provide the fill amount to the vehicle associated with the smart fuel gauge. At step 204, the system transmits the offer to the smart fuel gauge.

At step 205, the smart fuel gauge is presented with the offer. The offer can be manually accepted by the user of the smart fuel gauge. In other embodiments, the system may be configured to allow for the smart fuel gauge to automatically accept the offer. In these optional systems, further action can be taken by the smart fuel gauge, such as changing the navigation system of the vehicle to provide directions to the fuel station for which the offer was provided and accepted by the smart fuel gauge.

At step 206, the gas station computing device receives payment processing information from the smart fuel gauge (or via a third party system linking the smart fuel gauge and the fuel station computing device). At this point, the fill amount will be provided and once completed, the gas station computing device will be alerted of the completion and confirm the completion to the smart fuel gauge. Optionally, the smart fuel gauge can confirm completion by checking with sensors associated with the fuel tank of the vehicle to ensure the appropriate fill amount was actually received.

At step 207, the transaction is completed and payment is processed for the transaction. At this point, the process terminates at step 208.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of a special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. It is possible to modify or customize general-purpose systems to be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware specialized through computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing a smart fuel gauge and related smart fuel gauge apparatus:
a smart fuel gauge apparatus comprising a first processor, a first non-volatile computer readable memory and a first data communications means;
wherein said first processor is communicatively connected to said communications means, and wherein said first non-volatile computer-readable memory is configured with computer instructions configured to instruct said first processor to:
receive a fuel level reading;
calculate a fill amount, said fill amount being the delta between said fuel level reading and a set capacity amount; and
transmit said fill amount, via said communications means, to one or more fuel station computing devices;
said fuel station computing device comprising a second processor, a second non-volatile computer readable memory and a second data communications means, wherein said second non-volatile computer-readable memory is configured with computer instructions configured to instruct said second processor to:
receive said fill amount;
generate an offer to provide fuel in the amount of said fill amount, wherein said offer is based at least in part on said fill amount; and
transmit said offer to said smart fuel gauge apparatus.

2. The system of claim 1, said first processor is communicatively connected to said communications means, and wherein said first non-volatile computer-readable memory is configured with computer instructions configured to instruct said first processor to:
receive said offer from said fuel station computing device; and
transmit to said fuel station computing device an acceptance of said offer.

3. The system of claim 2, wherein second data communications means, wherein said second non-volatile computer-readable memory is configured with computer instructions configured to instruct said second processor to:
receive said acceptance of said offer from said smart fuel gauge apparatus;
receive payment processing information; and
transmit, upon completion of fulfilling provision of fuel, a completion confirmation to said smart fuel gauge apparatus.

4. The system of claim 3, wherein said first processor is communicatively connected to said communications means, and wherein said first non-volatile computer-readable memory is configured with computer instructions configured to instruct said first processor to:
receive said completion confirmation from said fuel station computing device; and
finalize payment on said offer.

5. The system of claim 4, wherein second data communications means, wherein said second non-volatile computer-readable memory is configured with computer instructions configured to instruct said second processor to:
receive confirmation of said payment on said offer; and
transmit a receipt for said payment to said smart fuel gauge apparatus.

6. A method for providing a smart fuel gauge and related smart fuel gauge apparatus:
receiving a fuel level reading;
calculating a fill amount, said fill amount being the delta between said fuel level reading and a set capacity amount; and
transmitting said fill amount, via said communications means, to one or more fuel station computing devices;
receiving said fill amount at a first fuel station computing device of said one or more fuel station computing devices;
generating an offer to provide fuel in the amount of said fill amount, wherein said offer is based at least in part on said fill amount; and
transmitting said offer to said smart fuel gauge apparatus.

7. The method of claim 6, further comprising the steps of:
receiving said offer from said fuel station computing device; and
transmitting to said fuel station computing device an acceptance of said offer.

8. The method of claim 7, further comprising the steps of:
receiving said acceptance of said offer from said smart fuel gauge apparatus;
receiving payment processing information; and
transmitting, upon completion of fulfilling provision of fuel, a completion confirmation to said smart fuel gauge apparatus.

9. The method of claim 8, further comprising the steps of:
receiving said completion confirmation from said fuel station computing device; and
finalizing payment on said offer.

10. The method of claim 9, further comprising the steps of:
receiving confirmation of said payment on said offer; and
transmitting a receipt for said payment to said smart fuel gauge apparatus.
